(19) United States
(12) Patent Application Publication
(10) Pub. No.: US 2018/0020078 A1
(43) Pub. Date: Jan. 18, 2018

(54) Recipient-specific Scheduling of Electronic Communication

(71) Applicant: Rise Interactive Media & Analytics, LLC, Chicago, IL (US)

(72) Inventors: Brent Laufenberg, Chicago, IL (US); Eric Sherlock, Chicago, IL (US); Joy Michele Wilson, Chicago, IL (US); Michael Staszel, Chicago, IL (US); Josh Friedlander, Chicago, IL (US); Kamilia Messaoudi, Chicago, IL (US); Kirill Temlyakov, Chicago, IL (US); Erik Severinghaus, Chicago, IL (US)

(21) Appl. No.: 15/213,331

(22) Filed: Jul. 18, 2016

(51) Int. Cl. H04L 29/08; H04L 12/58

(52) U.S. Cl. CPC H04L 67/32; H04L 67/02; H04L 51/14; H04L 51/22

(57) ABSTRACT

An embodiment may involve obtaining a recipient-specific record of interaction data for a particular recipient, the recipient-specific record including, for each of a plurality of electronic communications: (i) a respective timestamp indicating a time the respective electronic communication was transmitted and (ii) a respective indication of whether a client device requested a respective web resource using an individual identifier embedded in the respective electronic communication. The embodiment may further involve determining a particular time at which to send a further electronic communication to the particular recipient or another recipient, with the particular time selected based on respective timestamps from the recipient-specific record that are associated with the respective web resources, and transmitting an instruction to an electronic communication server device, with reception of the instruction causing the electronic communication server device to transmit the further electronic communication to the particular recipient or the other recipient at the particular time.

### BACKGROUND

Computer-mediated communication refers to the transmission of electronic communications between electronic devices. One example of a computer-mediated format is electronic mail (email). Other formats of computer-mediated communication include instant messaging, text messaging, push messaging, chat rooms, online forums, and social network services.

Although email has been around for decades, it is still a predominant method of computer-mediated communication. Today, email applications facilitate the storage of thousands of individual emails. Within a user's email application, emails can easily become “buried” under subsequently-received emails, and can even go unread.

In some cases, it may be desirable for recipients to read certain emails in a timely fashion rather than having the emails lost amongst other messages in the recipients' inboxes. For example, it may be desirable for recipients to read marketing emails in a timely fashion, such as emails offering products and/or services to recipients possibly on a time-limited basis. Therefore, it may also be desirable for these emails to be at or near the top of a recipient's inbox when the recipient views his or her email.

### SUMMARY

The embodiments herein involve, but are not limited to, ways in which an electronic communication can be scheduled for delivery to a recipient so the electronic communication has a high likelihood of being viewed. In particular, the computer implementations described hereafter may obtain a record of information about when electronic communications sent to a particular recipient are typically viewed, and use the record of information to select a particular time to transmit a future electronic communication to the particular recipient or another recipient. The record of information can be obtained by tracking the use of individual identifiers that are embedded in electronic communications and are specific to particular recipients. Machine learning techniques can be used to calculate the particular time to transmit the future electronic communication.

A first example embodiment may involve obtaining a recipient-specific record of interaction data for a particular recipient of electronic communications. The recipient-specific record of interaction data may include, for each of a plurality of electronic communications transmitted to the particular recipient at a plurality of different times: (i) a respective timestamp indicating a time the respective electronic communication was transmitted and (ii) a respective indication of whether a client device requested a respective web resource using an individual identifier embedded in the respective electronic communication. The first example embodiment may further involve determining a particular time at which to send a further electronic communication to the particular recipient or another recipient, with the particular time selected based on respective timestamps from the recipient-specific record of interaction data that are associated with the respective web resources. The first example embodiment may also involve transmitting an instruction to an electronic communication server device, with reception of the instruction causing the electronic communication server device to transmit the further electronic communication to the particular recipient or other recipient at the particular time. The further electronic communication may include a further individual identifier corresponding to a further web resource.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a computing system, according to an example embodiment.

FIG. 2A depicts an email architecture, according to an example embodiment.

FIG. 2B depicts another email architecture, according to an example embodiment.

FIG. 3 illustrates a schematic drawing of a computing device, according to an example embodiment.

FIG. 4 illustrates a schematic drawing of a networked server cluster, according to an example embodiment.

FIG. 5 is a conceptual illustration of customizing electronic communications, according to an example embodiment.

FIG. 6 is a conceptual illustration of tracking interactions with electronic communications, according to an example embodiment.

FIG. 7A depicts a recipient-specific record of interaction data, according to an example embodiment.

FIG. 7B depicts another recipient-specific record of interaction data, according to an example embodiment.

FIG. 7C depicts another recipient-specific record of interaction data, according to an example embodiment.

FIG. 8 depicts a flow chart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, use of the terms “maximum” and “minimum” herein refer to a desirable outcome to achieve, but do not imply that the outcome must be achieved. For instance, a goal of a function may be to select a maximum or minimum value, but there is no guarantee that the value selected is actually a maximum or minimum. Instead, the value selected may be close to a maximum or minimum value (e.g., within a threshold extent), or the function may take steps that are expected to result in a maximum or minimum value, but may not achieve this goal in all situations. Thus, any sort of optimization described herein may be in the statistical sense, and an actual optimal outcome is not required.

### 1. OVERVIEW

As noted above, with some applications for managing electronic communications, a problem can arise where electronic communications that are not read shortly after the electronic communications are sent become “buried” under subsequently-received electronic communications. These buried electronic communications may go unread. For instance, within a user's email application, an unread email can be progressively shifted further back (or lower) in a queue of emails as additional emails are received.

Further, for some types of electronic communications, it may be desirable for recipients to read the electronic communications within a timely fashion. For instance, it may be desirable for recipients to read marketing emails, such as emails offering products and/or services on a time-limited basis, within a limited time period of when the emails are sent to the recipients. Therefore, it may also be desirable for these emails to be at or near the top of a recipient's inbox when the recipient views his or her email.

The embodiments herein support methods, devices, and systems for scheduling electronic communications to a particular recipient so the electronic communication has a high likelihood of being viewed. Some of the embodiments herein support methods, devices, and systems for scheduling electronic communication to a particular recipient so the electronic communication may, for example, be viewed within a limited period of time. The embodiments herein may make use of information regarding when electronic communications sent to a particular recipient are typically viewed so as to determine a particular time to transmit a future electronic communication to the particular recipient or another recipient. For instance, some embodiments may involve determining a particular time to transmit a future electronic communication to the particular recipient or other recipient such that the recipient is likely to view the electronic communication within a limited time period of when the electronic communication is sent. As discussed below, in some examples, the other recipient may be a recipient having similar characteristic data as the particular recipient.

Particularly, the embodiments herein describe ways of obtaining a recipient-specific record of interaction data for a particular recipient of electronic communications. The record of interaction data may include information pertaining to when the particular recipient typically views the electronic communications. The recipient-specific record of interaction data may be used to determine a particular time at which to send an electronic communication to the particular recipient or another recipient in order to achieve a desired goal. For instance, the goal may be to determine a particular time to send an electronic communication to the particular recipient such that there is a high likelihood that the recipient will view the electronic communication or that there is a high likelihood that the recipient will view the electronic communication within a limited period of time. Alternatively, the goal may be to determine a particular time to send an electronic communication to the particular recipient such that there is a high likelihood that the recipient will activate a user-activatable hyperlink embedded in the electronic communication.

According to one approach, a recipient-specific record of interaction data for a particular recipient may be obtained by tracking the use of individual identifiers that are specific to the particular recipient and embedded in electronic communications sent to the particular recipient at a plurality of different times. For instance, an electronic communication sent to the particular recipient may include a uniquely-customized address to images or other files that may be downloaded when the electronic communication is viewed. The address may be customized to the particular recipient, to allow a server that hosts the image or other file, or a server that redirects a request to another server that hosts the image or other file, to track when the recipient views the electronic communication. Similarly, an electronic communication sent to the particular recipient may include a user-activatable hyperlink, and the user-activatable hyperlink may have an address that is customized to the particular recipient to track when the recipient activates the hyperlink. Other types of individual identifiers are also possible, such as number or text strings.

The embodiments herein may make use of one or more computing devices executing machine learning operations to calculate particular times to transmit electronic communications to particular recipients. Machine learning can be used to calculate, based on a recipient-specific record of interaction data, a particular time that achieves a particular goal. For instance, the goal may be to minimize a time between transmission of an electronic communication and viewing of the electronic communication by a particular recipient. Or the goal may be to maximize an estimated likelihood that a particular recipient activates a user-activatable hyperlink in an electronic communication. Other examples are also possible.

### 2. EXAMPLE COMPUTING DEVICES AND ELECTRONIC COMMUNICATION ARCHITECTURES

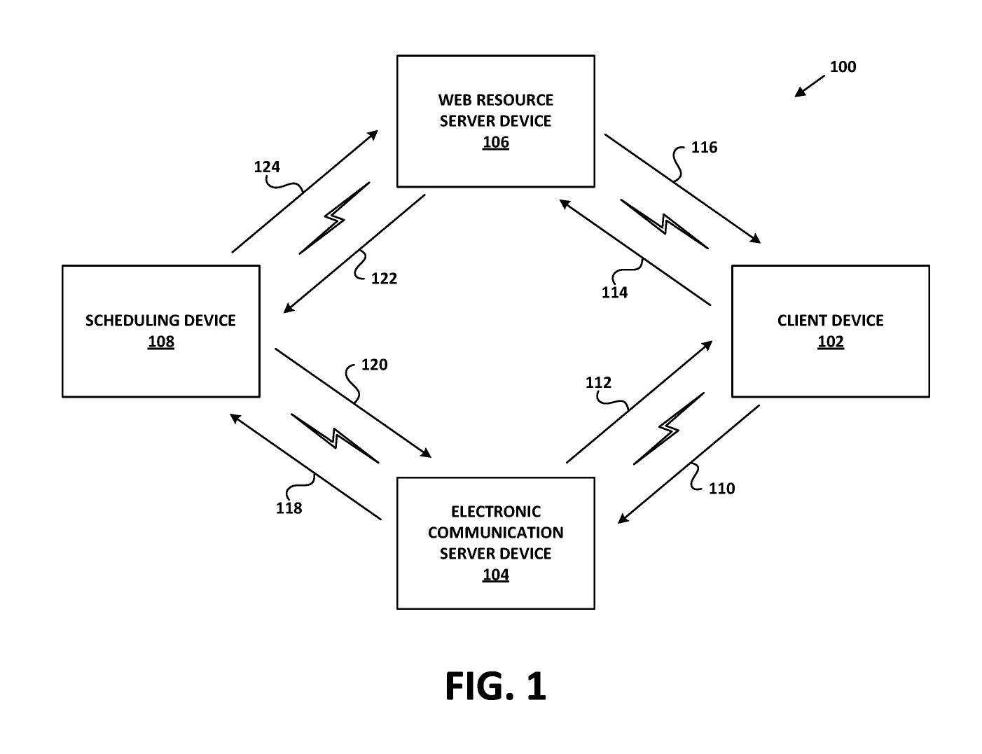

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to send data 110 to and/or receive data 112 from an electronic communication server device 104 in accordance with the embodiments described herein. For example, client device 102 may be configured to receive electronic communications from electronic communication server device 104.

Further, client device 102 may be configured to transmit data 114 to and/or receive data 116 from web resource server device 106. As an example, client device 102 may be configured to transmit a request for a web resource to the web resource server device 106 and receive the requested web resource from the web resource server device 106. Alternatively, the client device 102 may be configured to transmit a request for a web resource to the web resource server device 106, and the web resource server device 106 may in turn redirect the request to another server device (not shown) that ultimately provides the requested web resource to the client device 102. The request may include an individual identifier which is specific to a particular recipient of electronic communications. For example, the request may include a uniquely-customized address (e.g., a Uniform Resource Locator or “URL”) which is specific to a particular recipient of electronic communications. Alternatively, the request may include a number or text string which is specific to a particular recipient of electronic communications. Other examples are possible as well. The web resource may be any type of digital object which can be accessed through the web resource server device 106. As one example, the web resource may be an image. As another example, the web resource may be a Hypertext Markup Language (HTML) file which a web browser of the client device 102 may use to render a web page.

Electronic communication server device 104 may be any type of server device (e.g., an email server) configured to carry out the electronic communication server operations described herein. Electronic communication server device 104 may be configured to send data 112 to and/or receive data 110 from client device 102. In addition, electronic communication server device 104 may be configured to send data 118 to and/or receive data 120 from scheduling device 108. As an example, electronic communication server device 104 may be configured to receive from scheduling device 108 instructions for sending one or more electronic communications to particular recipients. Electronic communication server device 104 may also be configured to send to scheduling device 108 timestamps indicating times that respective electronic communications were transmitted to particular recipients.

Web resource server device 106 may be any type of server device (e.g., a web server) arranged to carry out the web resource server operations described herein. Web resource server device 106 may configured to send data 116 to and/or receiver data 114 from client device 102. In addition, web resource server device 106 may be configured to send data 122 to and/or receive data 124 to scheduling device 108. As an example, web resource server device 106 may receive a request for a web resource from client device 102 and send a corresponding web resource to client device 102. As another example, web resource server device 106 may receive a request for a web resource from client device 102, and redirect the request to another server device (not shown).

Scheduling device 108 may be any type of device arranged to carry out the scheduling operations described herein. Scheduling device 108 may be configured to send data 120 to and/or receive data 118 from electronic communication server device 104. And scheduling device 108 may be configured to send data 124 to and/or receive data 122 from web resource server device 106.

In the communication system 100 of FIG. 1, client device 102 may communicate with electronic communication server device 104 and web resource server device 106 via one or more wireline or wireless interfaces. In addition, scheduling device 108 may communicate with electronic communication server device 104 and web resource server device 106 via one or more wireline or wireless interfaces.

In one example, the scheduling device 108 may incorporate the electronic communication server device 104 (not shown). Regardless of the exact architecture, the operations of client device 102, electronic communication server device 104, web resource server device 106, and scheduling device 108, as well as any other operation associated with the architecture of FIG. 1, can be carried out by one or more computing devices. These computing devices may be organized in a standalone fashion, in cloud-based (networked) computing environments, or in other arrangements.

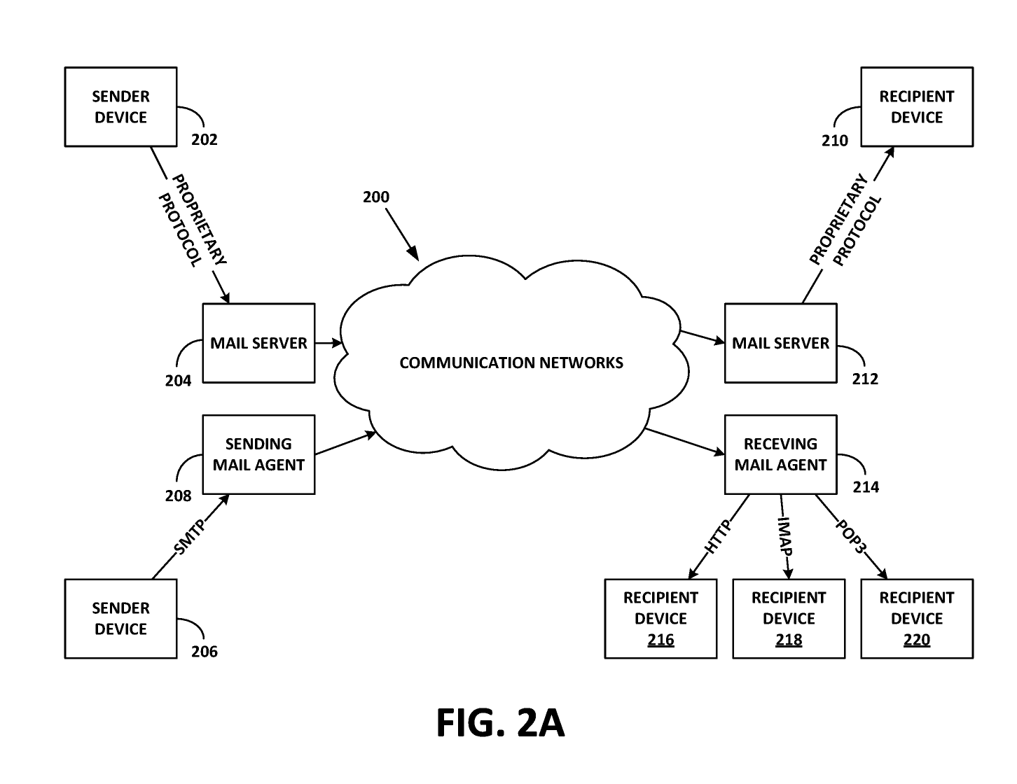

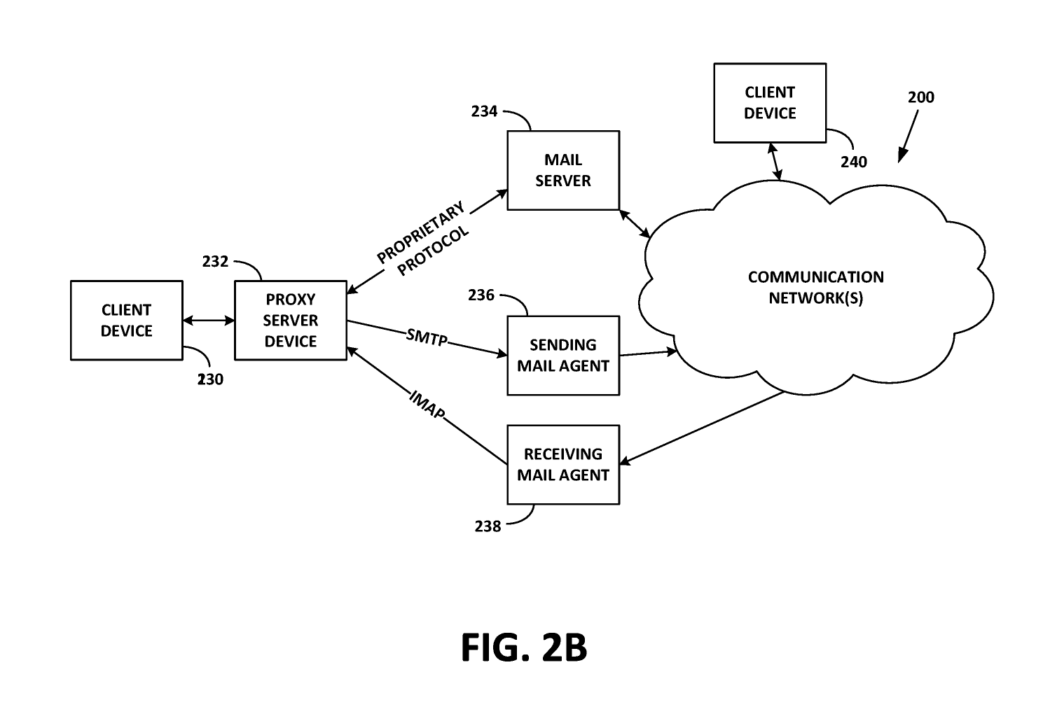

FIG. 2A depicts an example email architecture for transmission of electronic communications. While aspects of the embodiments herein are described in the context of email applications, similar architectures may exist for other types of computer-mediated communication applications, such as messaging applications (e.g., text messaging, instant messaging, and social network messaging applications). Thus, any of the embodiments described herein may be used with messaging applications, or any other type of electronic communication application. The focus below on email applications is for purposes of example.

Sender device 202 is associated with mail server 204, and may transmit email messages via a proprietary protocol to mail server 204. Mail server 204 may, in turn, forward these email messages to one or more mail servers and/or receiving mail agents so that these email messages can be delivered to one or more recipients.

Sender device 206 is associated with sending mail agent 208, and may transmit email messages via the Simple Mail Transfer Protocol (SMTP) to sending mail agent 208. Like mail server 204, sending mail agent 208 may forward these email messages to one or more mail servers and/or receiving mail agents so that these email messages can be delivered to one or more recipients.

Communication network(s) 200 interconnect mail server 204, sending mail agent 208, mail server 212, and receiving mail agent 214. Communication network(s) 200 may include the Internet, and/or various other private or public networks. In some embodiments, communication network(s) 200 operate using the Internet Protocol (IP), but other protocols may be used as well as or instead of IP.

Recipient device 210 is associated with mail server 212, and may receive email messages via a proprietary protocol from mail server 212. The proprietary protocol used between recipient device 210 and mail server 212 may be the same as or different from the proprietary protocol used between sender device 202 and mail server 204. Mail server 212 may receive email messages from various other mail servers and sending mail agents via communication network(s) 200.

Receiving mail agent 214 may also receive email messages from various mail servers and sending mail agents via communication network(s) 200. Additionally, receiving mail agent 214 may provide these email messages to their designated recipients via one or more protocols. For instance, FIG. 2A depicts receiving mail agent 214 transmitting email messages to recipient device 216 using the HyperText Transfer Protocol (HTTP), to recipient device 218 using the Internet Message Access Protocol (IMAP), and to recipient device 220 using the Post Office Protocol 3 (POP3). However, a receiving mail agent may use more or fewer protocols to transmit email messages to more or fewer recipient devices.

FIG. 2A depicts just one possible email architecture, and the embodiments herein may operate in other types of email architectures. Also, FIG. 2A illustrates logical elements. Thus, for instance, in some email architectures, sending mail agents and receiving mail agents may be combined in the same physical device. Similarly, mail servers, such as mail servers 204 and 212, may include both sending and receiving functions. Further, sender devices and recipient devices may include the ability to both send and receive email messages. Moreover, protocols other than SMTP, HTTP, IMAP, and POP3 may be used to send or receive email messages.

FIG. 2B depicts another email architecture. In FIG. 2B, client device 230 may include both sender and recipient functionality, and may communicate via proxy server device 232. The protocols used between client device 230 and proxy server device 232 may be standardized or proprietary.

Client device 230 may exchange email messages via one or more of mail server 234, sending mail agent 236, and receiving mail agent 238. As shown in FIG. 2B, mail server 234 may communicate with proxy server device 232 using a proprietary protocol, sending mail agent 236 may communicate with proxy server device 232 using SMTP, and receiving mail agent 238 may communicate with proxy server device 232 using IMAP. Other protocols may be used. Each of mail server 234, sending mail agent 236, and receiving mail agent 238 may also communicate with other devices, such as client device 240, via communication network(s) 200.

Proxy server device 232 may translate between the protocol used by client device 230 and proxy server device 232, and any of SMTP, IMAP, and the proprietary protocol used by mail server 234. Thus, proxy server device 232 may serve to manage one or more email, messaging, or other communication sessions between client device 230 and various other entities.

In some cases, client device 230 might not communicate directly with one or more of mail server 234, sending mail agent 236, and receiving mail agent 238. Thus, client device 230 may communicate instead with proxy server device 232, and proxy server device 232 may communicate directly with mail server 234, sending mail agent 236, and/or receiving mail agent 238.

Client device 240 may be a client device like client device 230. However, client device 240 might communicate via a proxy server device, such as proxy server device 232, or may communicate in a more standalone or direct fashion with various email and/or messaging servers.

Electronic communication server device may be represented by any one or more of mail server 204, sending mail agent 206, proxy server device 232, mail server 234, or sending mail agent 236. Other examples are possible.

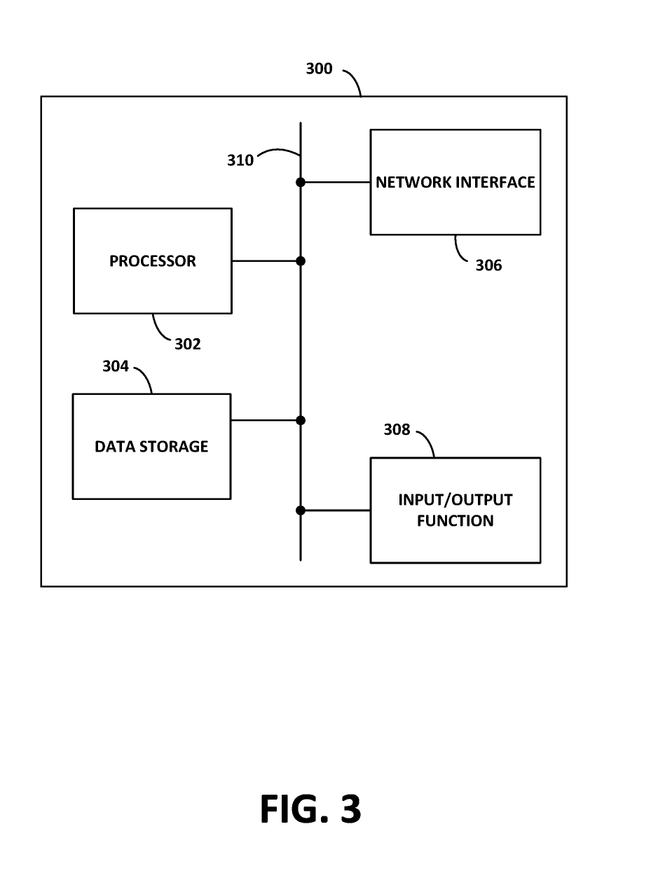

FIG. 3 is a simplified block diagram representing a computing device 300, illustrating some of the functional components that could be included in a computing device arranged to operate in accordance with the embodiments herein. Example computing device 300 could be a client device, a server device, or some other type of computational platform. For purpose of simplicity, this specification may equate computing device 300 to a server from time to time. Nonetheless, the description of computing device 300 could apply to any component used for the purposes described herein.

In this example, computing device 300 includes a processor 302, a data storage 304, a network interface 306, and an input/output function 308, all of which may be coupled by a system bus 310 or a similar mechanism. Processor 302 can include one or more CPUs, such as one or more general purpose processors and/or one or more dedicated processors (e.g., application specific integrated circuits (ASICs), digital signal processors (DSPs), network processors, etc.).

Data storage 304, in turn, may comprise volatile and/or non-volatile data storage and can be integrated in whole or in part with processor 302. Data storage 304 can hold program instructions, executable by processor 302, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 304 may contain program instructions, perhaps stored on a non-transitory, computer-readable medium, executable by processor 302 to carry out any of the methods, processes, or operations disclosed in this specification or the accompanying drawings.

Network interface 306 may take the form of a wireline connection, such as an Ethernet, Token Ring, or T-carrier connection. Network interface 306 may also take the form of a wireless connection, such as IEEE 802.11 (Wifi), BLUETOOTH®, or a wide-area wireless connection. However, other forms of physical layer connections and other types of standard or proprietary communication protocols may be used over network interface 306. Furthermore, network interface 206 may comprise multiple physical interfaces.

Input/output function 308 may facilitate user interaction with example computing device 300. Input/output function 308 may comprise multiple types of input devices, such as a keyboard, a mouse, a touch screen, and so on. Similarly, input/output function 308 may comprise multiple types of output devices, such as a screen, monitor, printer, or one or more light emitting diodes (LEDs). Additionally or alternatively, example computing device 300 may support remote access from another device, via network interface 306 or via another interface (not shown), such as a universal serial bus (USB) or high-definition multimedia interface (HDMI) port.

Computing device 300 may represent any client device, server device, or other device depicted in any of the drawings herein.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

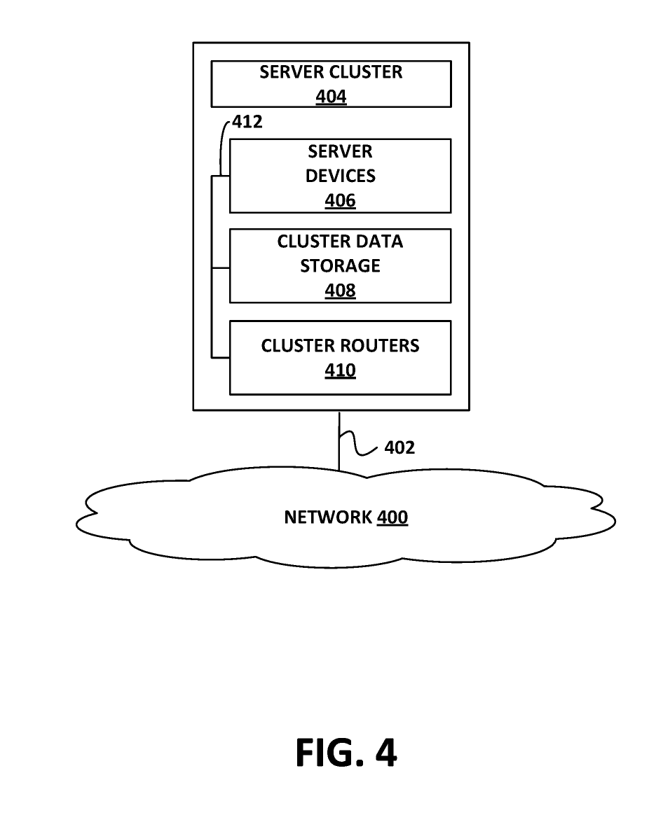

FIG. 4 depicts a cloud-based server cluster 404 in accordance with an example embodiment. In FIG. 4, functions of a server device, such as scheduling device 108 (as represented by computing device 300) may be distributed between server devices 406, cluster data storage 408, and cluster routers 410, all of which may be connected by local cluster network 412. The number of server devices, cluster data storages, and cluster routers in server cluster 404 may depend on the computing task(s) and/or applications assigned to server cluster 404.

For example, server devices 406 can be configured to perform various computing tasks of computing device 300. Thus, computing tasks can be distributed among one or more of server devices 406. To the extent that these computing tasks can be performed in parallel, such a distribution of tasks may reduce the total time to complete these tasks and return a result. For purpose of simplicity, both server cluster 404 and individual server devices 406 may be referred to as “a server device.” This nomenclature should be understood to imply that one or more distinct server devices, data storage devices, and cluster routers may be involved in server device operations.

Cluster data storage 408 may be data storage arrays that include disk array controllers configured to manage read and write access to groups of hard disk drives. The disk array controllers, alone or in conjunction with server devices 406, may also be configured to manage backup or redundant copies of the data stored in cluster data storage 408 to protect against disk drive failures or other types of failures that prevent one or more of server devices 406 from accessing units of cluster data storage 408.

Cluster routers 410 may include networking equipment configured to provide internal and external communications for the server clusters. For example, cluster routers 410 may include one or more packet-switching and/or routing devices configured to provide (i) network communications between server devices 406 and cluster data storage 408 via cluster network 412, and/or (ii) network communications between the server cluster 404 and other devices via communication link 402 to network 400.

Additionally, the configuration of cluster routers 410 can be based at least in part on the data communication requirements of server devices 406 and cluster data storage 408, the latency and throughput of the local cluster networks 412, the latency, throughput, and cost of communication link 402, and/or other factors that may contribute to the cost, speed, fault-tolerance, resiliency, efficiency and/or other design goals of the system architecture.

As a possible example, cluster data storage 408 may include any form of database or data storage, such as a structured query language (SQL) database or data storage or a non-structured query language (NoSQL) database or data storage. Various types of data structures may store the information in such a data storage system, including but not limited to tables, arrays, lists, trees, and tuples. Furthermore, any databases in cluster data storage 408 may be monolithic or distributed across multiple physical devices.

Server devices 406 may be configured to transmit data to and receive data from cluster data storage 408. This transmission and retrieval may take the form of SQL queries or other types of database queries, and the output of such queries, respectively. Additional text, images, video, and/or audio may be included as well.

### 3. EXAMPLE ELECTRONIC COMMUNICATION INTERACTION TRACKING

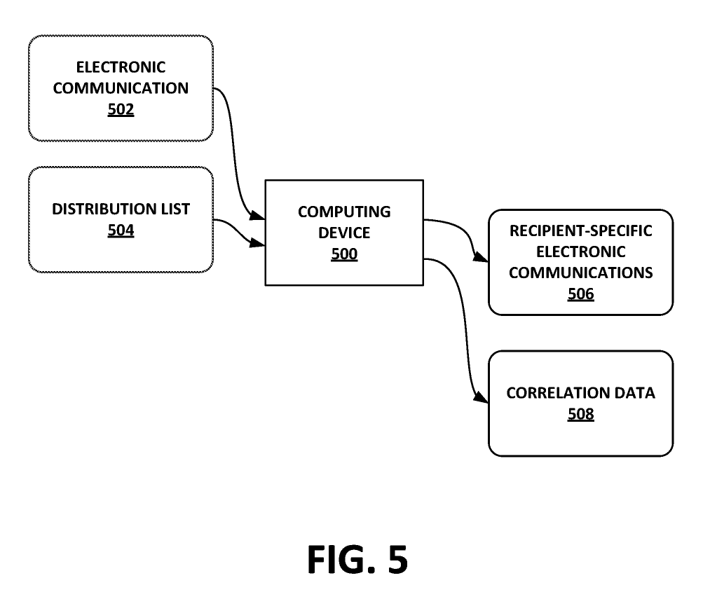

Although FIGS. 5, 6, and 7A-7C describe electronic communication interaction tracking using individual identifiers in the form of uniquely-customized addresses, the description is not meant to be limiting. Electronic communications may similarly be customized and tracked using other types of individual identifiers. FIG. 5 is a conceptual illustration of customizing electronic communications, according to an example embodiment. In FIG. 5, computing device 500 receives as input an electronic communication 502 and a distribution list 504. The electronic communication 502 includes an embedded reference to a web resource. The embedded reference may specify an address of a web resource on a computer network and a mechanism for retrieving the web resource.

The electronic communication 502 may be an email including an image or other file to be downloaded when the email is displayed. The image or other file may be embedded in the email using a URL which specifies an address of the image or other file. The electronic communication 502 may also be an email including a user-activatable hyperlink. The user-activatable hyperlink may include a URL for a webpage. The anchor of the user-activatable hyperlink may be text or an image of the electronic communication 502.

The distribution list 504 may include a plurality of recipients to which the electronic communication 502 is to be sent. For instance, the distribution list may include a plurality of email addresses.

Computing device 500 may use the electronic communication 502 and the distribution list 504 to determine recipient-specific electronic communications 506 and correlation data 508. For each recipient of the distribution list 504, computing device 500 may obtain a uniquely-customized address to the web resource, and output a recipient-specific version of the electronic communication 502 in which the embedded reference is replaced with the uniquely-customized address. The uniquely-customized address may, for instance, be a URL which includes an alphanumeric string, and the alphanumeric string may be unique to a particular electronic communication of the recipient-specific electronic communications 506. In one example, the unique alphanumeric string may be appended to the end of a common base URL to create a virtual URL.

For instance, a website may be configured to support a number of virtual URLs that all reference the same object. However, each of these virtual URLs may contain a unique alphanumeric string that corresponds to an electronic communication sent to a particular recipient. When any such virtual URL is requested, the object may be provided. The website may be further configured to record when (e.g., a time) and from where (e.g., the source IP address) each of these virtual URLs is accessed. As an example, if the URL of an object is http://www.example.com/image1.jpg, two possible virtual URLs also referring to this object for purposes of tracking may be http://www.example.com/image1_VDGtDET5.jpg and http://www.example.com/image1_BqG22.jpg.

The correlation data 508 may link the uniquely-customized addresses with particular electronic communications in the recipient-specific electronic communications 506. For instance, the correlation data 508 may map a first uniquely-customized address with a first recipient-specific electronic communication to a first recipient, map a second uniquely-customized address with a second recipient-specific electronic communication to a second recipient, and so forth.

The correlation data 508 may also include or be modified to include timestamps indicating when each of the recipient-specific electronic communications was transmitted to the particular recipient. For instance, computing device 500 may receive data from another computing device that is indicative of the timestamps, and add the timestamps to the correlation data 508.

In addition, the correlation data 508 may also specify a web resource type of the web resource to which the uniquely-customized address corresponds. For instance, the correlation data may specify whether the web resource is downloadable by a client device for display within an electronic communication or is embeddable in an electronic communication as a user-activatable hyperlink.

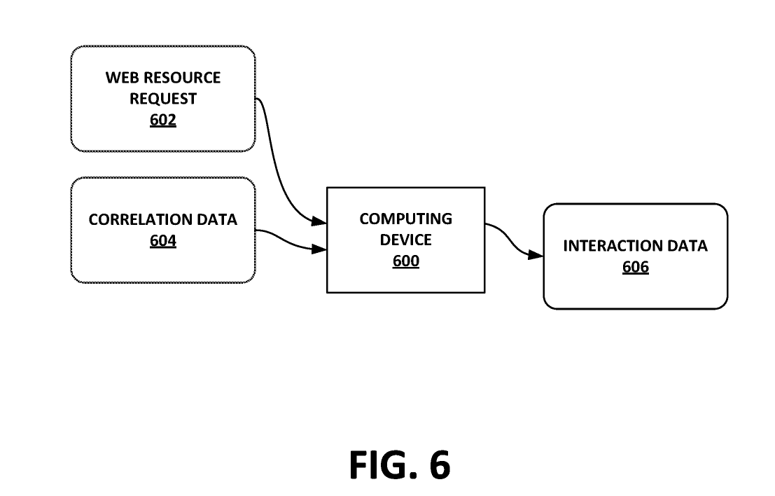

FIG. 6 is a conceptual illustration of tracking interactions with electronic communications, according to an example embodiment. In FIG. 6, a computing device 600, such as web resource server device 106 of FIG. 1, hosts web resources. Upon receipt of web resource request 602 from a client device, computing device 600 identifies, using a uniquely-customized address included in the web resource request 602, the requested web resource. The computing device 600 then provides the requested web resource to the client device.

In addition, the computing device 600 determines, using correlation data 604, that the uniquely-customized address corresponds to a particular electronic communication. Correlation data 604 may be obtained in the manner described above with reference to FIG. 5, or may be obtained in other manners as well. Correlation data 604 may link uniquely-customized addresses with particular electronic communications to particular recipients.

In one instance, in response to receiving the web resource request 602, the computing device 600 may perform a data lookup keyed to the uniquely-customized address. For example, computing device 600 may access the correlation data 604 to identify the particular electronic communication corresponding to the uniquely-customized address. Computing device 600 may then generate interaction data 606 indicating that the web resource in the particular electronic communication was accessed. The computing device 600 may log the interaction data 606 in a database and/or provide the interaction data 606 to another computing device.

In one instance, the interaction data 606 may include a time that the web resource in the particular communication was requested. If the correlation data 604 also includes a timestamp indicating when the particular electronic communication was transmitted, the computing device may calculate an elapsed time between when the particular electronic communication was transmitted and when the web resource in the particular electronic communication was requested. The interaction data 606 may optionally include an indication of the web resource type of the requested web resource.

Computing device 600 may repeat this interaction tracking process over time as computing device 600 receives various web resource requests from various client devices. A log of interaction data created by the computing device 600 or another computing device may also include indications of particular electronic communications that were sent to particular recipients but did not result in web resource requests. For instance, the computing device 600 may create a record that includes data for each particular electronic communication indicated in the correlation data 604.

Because the particular electronic communications from which the web resource requests originate are specific to particular recipients, the interaction data 606 logged by the computing device 600 (or continually provided to another computing device) may be filtered to form recipient-specific records of interaction data.

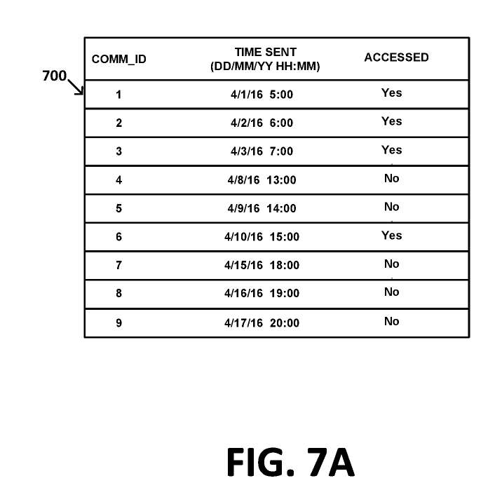

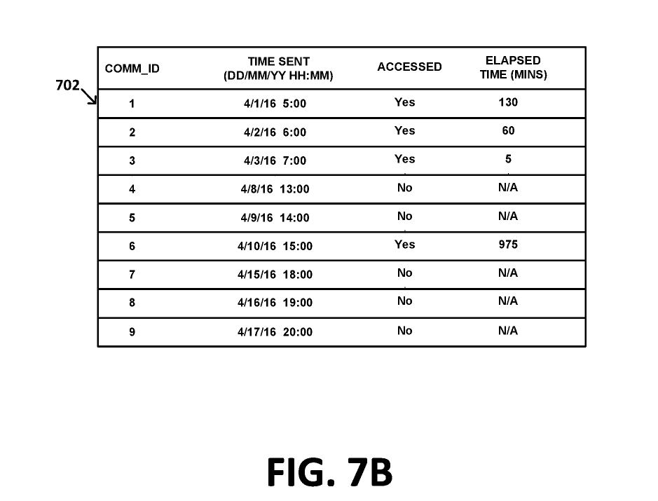

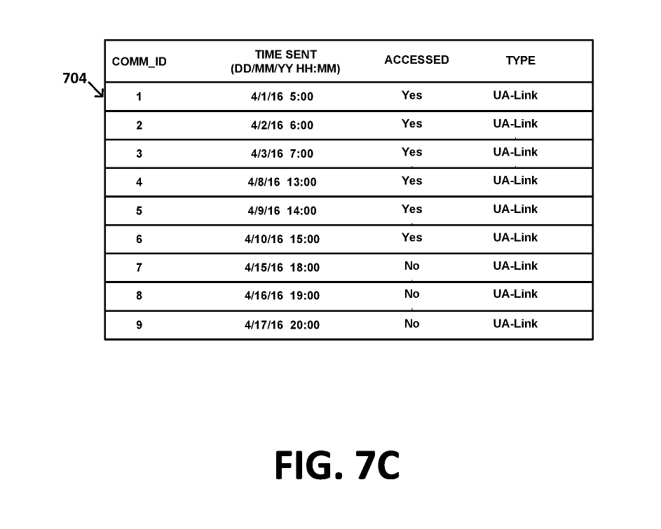

FIG. 7A depicts an example recipient-specific record of interaction data, according to an example embodiment. As shown in FIG. 7A, the recipient-specific record of interaction data may include, for each of a plurality of particular electronic communications 700, a timestamp indicative of when the particular electronic communication was sent and an indication of whether a client device requested a respective web resource using a uniquely-customized address embedded in the particular electronic communication. Although the time sent is expressed in FIG. 7A in terms of a date and time, in other examples, the time sent may be simply a day of the week.

FIG. 7B depicts another example recipient-specific record of interaction data, according to an example embodiment. The recipient-specific record of interaction data of FIG. 7B is similar to the recipient-specific record of interaction data of FIG. 7A except that the recipient-specific record of interaction data of FIG. 7B includes elapsed time data. For a given electronic communication 702 for which a client device requested a corresponding web resource, the recipient-specific record of interaction data indicates an elapsed amount of time between the time the electronic communication was sent and a time a request for the web resource was received.

In effect, the elapsed time data itself may be an implicit indication of whether a client device requested a respective web resource using a uniquely-customized address embedded in the particular electronic communication. If an amount of time is indicated, a computing device may interpret the presence of the amount of time to mean that the client device requested the web resource referenced in the particular electronic communication. On the other hand, if an amount of time is not indicated, a computing device may interpret the absence of the amount of time to mean that a client device did not request the web resource referenced in the particular electronic communication.

FIG. 7C depicts another example recipient-specific record of interaction data, according to an example embodiment. Unlike the example recipient-specific records of interaction data depicted in FIGS. 7A and 7B, the recipient-specific record of interaction data of FIG. 7C includes an indication of web resource type. By way of example, for each of the electronic communications 704 represented in FIG. 7C, the interaction data indicates that the type of web resource referenced in the particular electronic communication is “UA-Link” or user-activatable hyperlink. Although the recipient-specific record of interaction data depicted in FIG. 7C only includes interaction data for electronic communications in which the type of web resource referenced was a user-activatable link, the example is not meant to be limiting. Other recipient-specific records might also include interaction data for electronic communications referencing other types of web resources.

### 4. EXAMPLE ELECTRONIC COMMUNICATION SCHEDULING

Once a recipient-specific record of interaction data for a particular recipient is obtained, machine learning techniques may be used to determine a particular time at which to send future electronic communications to a particular recipient or to another recipient. One way of doing so is to use a maximum likelihood estimation method to maximize a likelihood function. Given a set of data, a maximum likelihood estimator may output one or more model parameters that maximize the likelihood function. For example, in the context of the present embodiments, the maximum likelihood estimator may output a particular time.

Nonetheless, other machine learning techniques may be used to embody the features discussed herein. Such techniques may include, but are not limited to, linear and non-linear regression, decision trees, support vector machines, random forests, hidden Markov models, and so on.

In one instance, a likelihood function may quantify, as a function of time of day, the likelihood that a web resource referenced in an electronic communication is accessed. A maximum likelihood estimator process executing on a computing device may calculate, using a recipient-specific record of interaction data, a particular time that maximizes the likelihood function. For instance, referring back to the recipient-specific record of interaction data of FIG. 7A, this particular record indicates that that web resources referenced in electronic communications sent to the particular recipient at 5:00, 6:00, 7:00 and 15:00 were accessed, whereas web resources referenced in electronic communications sent to the particular recipient at 13:00, 14:00, 18:00, 19:00, and 20:00 were not accessed. Given the data indicated in the record of FIG. 7A, the maximum likelihood estimator may calculate a particular time that is between 5:00 and 7:00. As the amount of data in the record grows, the quality of the estimate is expected to improve.

In another instance, a likelihood function may quantify as a function of day of the week the likelihood that a web resource referenced in an electronic communication is accessed. If a recipient-specific record of interaction data indicates that web resources referenced in electronic communications sent to a particular recipient on Tuesdays were accessed more often than web resources referenced in electronic communications sent on other days of the week, a maximum likelihood estimator may calculate a day of week of Tuesday.

In another instance, a likelihood function may quantify as a function of time of day an expected elapsed amount of time between when an electronic communication is transmitted and when a web resource referenced in the electronic communication is accessed. A maximum likelihood estimator process executing on a computing device may calculate, using a recipient-specific record of interaction data, a particular time that minimizes the elapsed amount of time between when an electronic communication is transmitted and when a web resource referenced in the electronic communication is accessed. For instance, referring back to the recipient-specific record of interaction data of FIG. 7B, this particular record indicates that web resources referenced in electronic communications sent to the particular recipient are accessed most quickly when the electronic communications are sent around 7:00. Given the data indicated in the record of FIG. 7B, the maximum likelihood estimator may calculate a particular time near 7:00.

In a similar manner, a likelihood function may quantify as a function of day of the week an expected elapsed amount of time between when an electronic communication is transmitted and when a web resource referenced in the electronic communication is accessed. A maximum likelihood estimator may then calculate, using a recipient-specific record of interaction data, a particular day of the week that minimizes the elapsed amount of time between when an electronic communication is transmitted and when a web resource referenced in the electronic communication is accessed.

In still another instance, a likelihood function may quantify, as a function of time of day, a likelihood that a user-activatable hyperlink in an electronic communication is activated. A maximum likelihood estimator process executing on a computing device may calculate, using a recipient-specific record of interaction data, a particular time that maximizes the likelihood that a user-activatable hyperlink in an electronic communication is activated. For instance, referring back to the recipient-specific record of interaction data of FIG. 7C, this particular record indicates that user-activatable links were activated in electronic communications transmitted at 5:00, 6:00, 7:00, 13:00, 14:00, and 15:00, but not activated in electronic communications transmitted at 18:00, 19:00, and 20:00. Given the data indicated in the record of FIG. 7C, the maximum likelihood estimator may calculate a particular time between 5:00 and 7:00 or between 13:00 and 15:00.

In a similar manner, a likelihood function may quantify, as a function of day of the week, a likelihood that a user-activatable hyperlink in an electronic communication is activated. A maximum likelihood estimator may then calculate, using a recipient-specific record of interaction data, a particular day of the week that maximizes the likelihood that a user-activatable hyperlink in an electronic communication is activated.

In some examples, a maximum likelihood estimator may calculate a particular time to schedule an electronic communication to a particular recipient using a recipient-specific record of interaction data for that particular recipient as well as recipient-specific records of interaction data for other recipients. For instance, when interaction data for a particular recipient is sparse, interaction data for other recipients may be relied upon to schedule a particular time to transmit an electronic communication to the particular recipient. When recipient-specific records for other participants are used, the interaction data pertaining to the particular recipient may be weighted more than interaction data corresponding to other participants. Similarly, in some examples, a maximum likelihood estimator may calculate a particular time to schedule an electronic communication to a particular recipient using recipient-specific records of interaction data for one or more other recipients and without using a recipient-specific record of interaction data for the particular recipient.

Further, in some examples, the other recipients whose interaction data is relied upon to determine the particular time for a particular recipient may be selected based upon similarities between the particular recipient and the other recipients. For instance, a database of characteristic data for a plurality of recipients may be collected. For at least some of the plurality of recipients, the characteristic data may identify one or any combination of: demographic information, time zone, digital behavior, online browsing details, device location data, past online transactions or purchases, membership or loyalty programs, etc. Given a particular recipient, a computing device may filter the database to identify other recipients having at least a portion of characteristic data matching the particular recipient's characteristic data. As one example, characteristic data for a particular recipient with sparse interaction data may indicate that the particular recipient has a particular income, commutes to work, and lives in a particular area. The computing device may use the database of characteristic data to identify other recipients that have a similar income, commute to work, and live in the particular area. The interaction data for the identified recipients may then be relied upon to schedule an electronic communication to the particular recipient. Other examples are possible as well.

In some examples, interaction data for a particular recipient may include interaction data for a first type of electronic communication, and a computing device may use the interaction data for the first type of electronic communication to determine a particular time at which to send a different type of electronic communication. By way of example, interaction data for a particular recipient may indicate when a user is active on a social media application (e.g., when a user posts on the social media application, views social media posts, sends messages via the social media application, or clicks on links using the social media application). A computing device may use the interaction data to determine a particular time to send an email or text message. For instance, a likelihood function may quantify as a function of time of day a likelihood that the particular recipient is active on the social media application. The computing device may then calculate, using the interaction data, a particular time of day that maximizes the likelihood that a user is active on the social media application, and schedule an email or text message for transmission to the particular recipient at the particular time of day.

As another example, interaction data for a particular recipient may indicate the particular recipient's interaction with emails, and a computing device may use the interaction data to schedule a time to provide a push notification or text message to the particular recipient. Thus, interaction data for a particular recipient pertaining to a first type of electronic communication can be leveraged to schedule a particular time to transmit a second type of electronic communication to the particular recipient. Similarly, interaction data for a particular recipient pertaining to a first type of electronic communication can be leveraged to schedule a particular time to transmit a second type of electronic communication to a different recipient having similar characteristic data to the particular recipient.

Other machine learning techniques may also be used, instead of or in addition to the use a maximum likelihood estimator, to determine a particular time at which to send electronic communications to a particular recipient.

In some examples, a computing device may apply a time offset to a particular time that has been determining using a machine learning techniques. Advantageously, the time offset may allow an electronic communication to be scheduled for transmission to a particular recipient just before a time when electronic communications are typically accessed by the particular recipient.

By way of example, a maximum likelihood estimator process executing on a computing device may calculate a first time of 8:45. The computing device may then subtract a time offset from the first time to determine the particular time to transmit an electronic communication. For instance, the time offset may be five minutes, such that the particular time is 8:40.

After determining a particular time to transmit an electronic communication to a particular recipient, the computing device may transmit an instruction to an electronic communication server device. The instruction may cause the electronic communication server device to transmit an electronic communication to the particular recipient at the particular time. For instance, the instruction may be transmitted at the particular time, causing the electronic communication server device to transmit the electronic communication immediately or shortly after reception. Alternatively, the instruction may be transmitted prior to the particular time and instruct the electronic communication server device to transmit the electronic communication at the particular time. Optionally, the electronic communication transmitted to the particular recipient at the particular time may include a uniquely-customized address corresponding to a web resource, such that a time when the electronic communication is accessed can be tracked.

Additionally or alternatively, after determining a particular time to transmit an electronic communication to a particular recipient, the computing device may store the particular time in a database. Such a database may include a plurality of recipients and corresponding transmission times for sending electronic communications to the particular recipients.

### 5. EXAMPLE OPERATIONS

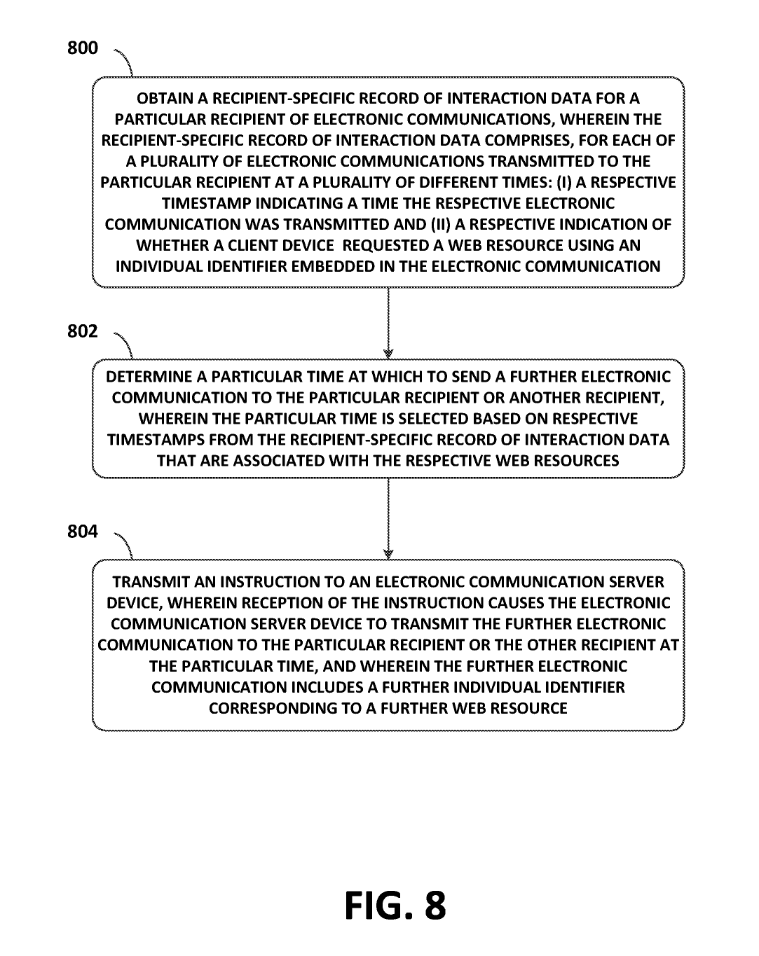

FIG. 8 is a flow chart illustrating an example embodiment. The process illustrated by FIG. 8 may be carried out by a computing device, such as computing device 300, and/or a cluster of computing devices, such as server cluster 404. However, the process can be carried out by other types of devices or device subsystems. For example, the process could be carried out by a portable computer, such as a laptop or a tablet device.

Block 800 may involve obtaining a recipient-specific record of interaction data for a particular recipient of electronic communications. The recipient-specific record of interaction data may include, for reach of a plurality of electronic communications transmitted to the particular recipient at a plurality of different times: (i) a respective timestamp indicating a time the respective electronic communication was transmitted and (ii) a respective indication of whether a client device requested a web resource using an individual identifier embedded in the electronic communication.

The plurality of different times may include a plurality of different times of day and/or a plurality of different days of the week.

Obtaining the recipient-specific record of interaction data may involve requesting and then responsively receiving the recipient-specific record from a data storage system. Alternatively, obtaining the recipient-specific record of interaction data may involve maintaining correlation data linking a plurality of individual identifiers with the plurality of electronic communications to the particular recipient, and using the correlation data to determine the recipient-specific record.

The electronic communications may be email communications and the particular recipient may be an email address or an entity that is associated with the email address. One or more of the respective web resources may be a first type that are downloadable by a client device for display within an email communication. One or more of the respective web resources may be a second type that is embeddable in an email communication as a user-activatable hyperlink.

Block 802 may involve determining a particular time at which to send a further electronic communication to the particular recipient or another recipient. The particular time may be selected based on respective timestamps from the recipient-specific record of interaction data that are associated with the respective web resources.

The particular time may be a particular time of day and/or a particular day of the week and/or a particular time of the year.

The recipient-specific record may also include, for respective electronic communications associated with respective web resources that were requested, respective indications of web resource type, and the particular time may be selected based also on the respective indications of web resource type.

Additionally or alternatively, the recipient-specific record may include, for respective electronic communications associated with respective web resources that were requested, respective elapsed amounts of time between when the respective electronic communications were transmitted and when the respective web resources were requested, and the particular time may be selected based also on the respective elapsed amounts of time.

Block 804 may involve transmitting an instruction to an electronic communication server device. Reception of the instruction may cause the electronic communication server device to transmit the further electronic communication to the particular recipient or the other recipient at the particular time. The further electronic communication may include a further individual identifier corresponding to a further web resource.

The electronic communication server device may be an email server device. Further, the computing device carrying out the process illustrated in FIG. 8 may incorporate the electronic communication server device.

Additional blocks, not explicitly illustrated in FIG. 8, may involve maintaining correlation data linking a plurality of individual identifiers with the plurality of electronic communications to the particular recipients, and using the correlation data to determine the recipient-specific record. Using the correlation data to determine the recipient-specific record may involve: (i) receiving an indication that a request for a given web resource including a given individual identifier was received at a given time; (ii) determining, using the correlation data, that the given individual identifier corresponds to a given electronic communication; and optionally (iii) determining an elapsed amount of time for the given electronic communication based on the given time when the request was received and a time the given electronic communication was transmitted.

The embodiments of FIG. 8 may be simplified by the removal of any one or more of the features shown therein. Further, these embodiments may be combined with features, aspects, and/or implementations of any of the previous figures or otherwise described herein.

### 6. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrently or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining, by one or more computing devices, a recipient-specific record of interaction data for a particular recipient of electronic communications, wherein the recipient-specific record of interaction data comprises, for each of a plurality of electronic communications transmitted to the particular recipient at a plurality of different times: (i) a respective timestamp indicating a time the respective electronic communication was transmitted and (ii) a respective indication of whether a client device requested a respective web resource using an individual identifier embedded in the respective electronic communication;
determining, by the one or more computing devices, a particular time at which to send a further electronic communication to the particular recipient or another recipient, wherein the particular time is selected based on respective timestamps from the recipient-specific record of interaction data that are associated with the respective web resources; and
transmitting, by the one or more computing devices, an instruction to an electronic communication server device, wherein reception of the instruction causes the electronic communication server device to transmit the further electronic communication to the particular recipient or another recipient at the particular time, and wherein the further electronic communication includes a further individual identifier corresponding to a further web resource.

2. The method of claim 1, wherein the electronic communications are email communications, the particular recipient is an email address, and the electronic communication server device is an email server device.

3. The method of claim 2, wherein the respective web resources are a first type that is downloadable by the client device for display within an email communication or a second type that is embeddable in an email communication as a user-activatable hyperlink.

4. The method of claim 3, wherein the recipient-specific record includes, for respective electronic communications associated with respective web resources that were requested, respective indications of web resource type, and wherein the particular time is selected based also on the respective indications of web resource type.

5. The method of claim 4, wherein the recipient-specific record includes, for respective electronic communications associated with respective web resources that were requested, respective elapsed amounts of time between when the respective electronic communications were transmitted and when the respective web resources were requested, and wherein the particular time is selected based also on the respective elapsed amounts of time.

6. The method of claim 4, wherein the further web resource comprises a web resource of the second type, and wherein determining the particular time comprises a maximum likelihood estimator calculating the particular time, based on the respective time stamps, the respective indications of whether the respective web resources were requested, and the respective indications of web resource type, to maximize an estimated likelihood that the user-activatable hyperlink is activated.

7. The method of claim 2, wherein the one or more computing devices incorporate the electronic communication server device.

8. The method of claim 1, wherein determining the particular time comprises a maximum likelihood estimator calculating the particular time, based on the respective timestamps and the respective indications of whether the respective web resources were requested, to maximize an estimated likelihood that the further web resource in the further electronic communication is accessed.

9. The method of claim 1, wherein determining the particular time comprises:
a maximum likelihood estimator calculating a first time, based on the respective timestamps and the respective indications of whether the respective web resources were requested, to maximize an estimated likelihood that the further web resource in the further electronic communication is accessed; and
subtracting a time offset from the first time to determine the particular time.

10. The method of claim 1, wherein the recipient-specific record includes, for respective electronic communications associated with respective web resources that were requested, respective elapsed amounts of time between when the respective electronic communications were transmitted and when the respective web resources were requested, and wherein the particular time is selected based also on the respective elapsed amounts of time.

11. The method of claim 10, wherein determining the particular time comprises a maximum likelihood estimator calculating the particular time, based on the respective timestamps and the respective elapsed amounts of time, to minimize an expected elapsed amount of time between when the further electronic communication is transmitted and when the further web resource in the further electronic communication is accessed.

12. The method of claim 10, wherein determining the particular time comprises:
a maximum likelihood estimator calculating a first time, based on the respective timestamps and the respective elapsed amounts of time, to minimize an expected elapsed amount of time between when the further electronic communication is transmitted and when the further web resource in the further electronic communication is accessed; and
subtracting a time offset from the first time to determine the particular time.

13. The method of claim 1, further comprising:
maintaining correlation data linking a plurality of individual identifiers with the plurality of electronic communications to the particular recipient; and
using the correlation data to determine the recipient-specific record.

14. The method of claim 13, wherein using the correlation data to determine the recipient-specific record comprises:
receiving an indication that a request for a given web resource including a given individual identifier was received at a given time;
determining, using the correlation data, that the given individual identifier corresponds to a given electronic communication; and
determining an elapsed amount of time for the given electronic communication based on the given time when the request was received and a time the given electronic communication was transmitted.

15. The method of claim 1, wherein the plurality of different times comprises a plurality of different times of day, and wherein the particular time comprises a particular time of a day.

16. The method of claim 1, wherein the plurality of different times comprises a plurality of different days of the week, and wherein the particular time comprises a particular day of the week.

17. An article of manufacture including a non-transitory computer readable-medium, having stored thereon program instructions that, upon execution by a computing device, cause the computing device to perform operations comprising:
obtaining a recipient-specific record of interaction data for a particular recipient of electronic communications, wherein the recipient-specific record of interaction data comprises, for each of a plurality of electronic communications transmitted to the particular recipient at a plurality of different times: (i) a respective timestamp indicating a time the respective electronic communication was transmitted and (ii) a respective indication of whether a client device requested a respective web resource using an individual identifier embedded in the respective electronic communication;
determining a particular time at which to send a further electronic communication to the particular recipient or another recipient, wherein the particular time is selected based on respective timestamps from the recipient-specific record of interaction data that are associated with the respective web resources; and
transmitting an instruction to an electronic communication server device, wherein reception of the instruction causes the electronic communication server device to transmit the further electronic communication to the particular recipient or the other recipient at the particular time, wherein the further electronic communication includes a further individual identifier corresponding to a further web resource.

18. The article of manufacture of claim 17, wherein the electronic communications are email communications, the particular recipient is an email address, and the electronic communication server device is an email server device.

19. The article of manufacture of claim 18, wherein the respective web resources are a first type that is downloadable by the client device for display within an email communication or a second type that is embeddable in an email communication as a user-activatable hyperlink.

20. A computing device comprising:
at least one processor;
memory; and
program instructions, stored in the memory, that upon execution by the at least one processor cause the computing device to perform operations comprising:
obtaining a recipient-specific record of interaction data for a particular recipient of electronic communications, wherein the recipient-specific record of interaction data comprises, for each of a plurality of electronic communications transmitted to the particular recipient at a plurality of different times: (i) a respective timestamp indicating a time the respective electronic communication was transmitted and (ii) a respective indication of whether a client device requested a respective web resource using an individual identifier embedded in the respective electronic communication;
determining a particular time at which to send a further electronic communication to the particular recipient or another recipient, wherein the particular time is selected based on respective timestamps from the recipient-specific record of interaction data that are associated with the respective web resources; and
transmitting an instruction to an electronic communication server device, wherein reception of the instruction causes the electronic communication server device to transmit the further electronic communication to the particular recipient or the other recipient at the particular time, wherein the further electronic communication includes a further individual identifier corresponding to a further web resource.
